(19) United States
(12) Patent Application Publication
(10) Pub. No.: US 2010/0091339 A1
(43) Pub. Date: Apr. 15, 2010

(54) IMAGE SCANNING APPARATUS AND SHADING CORRECTING METHOD THEREOF

(75) Inventors: Hee-sang KWON, Suwon-si (KR); Gyu-sok JUN, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/543,612

(22) Filed: Aug. 19, 2009

(30) Foreign Application Priority Data
Oct. 14, 2008 (KR) 2008-100602

(51) Int. Cl. H04N 1/40; H04N 1/04

(52) U.S. Cl. 358/461; 358/474

(57) ABSTRACT

An image scanning apparatus includes a first scanning unit to scan a first side of a conveyed document and detect a white area, a direction change unit to re-convey the conveyed document to a duplex scan path, a second scanning unit to scan the white area of the re-conveyed document, and a controller to perform a shading correction of the second scanning unit using scan data for the white area.

### CROSS-REFERENCE TO RELATED APPLICATIONS

This application claims the benefit under 35 U.S.C. §119(a) of Korean Patent Application No. 10-2008-100602, filed on Oct. 14, 2008, in the Korean Intellectual Property Office, the disclosure of which is incorporated herein by reference in its entirety.

### BACKGROUND

1. Field of the Invention

The present general inventive concept relates to an image scanning apparatus and a shading correcting method thereof. More particularly, the present general inventive concept relates to an image scanning apparatus in which a second scanning unit scans a white area detected by a first scanning unit to perform a shading correction of the second scanning unit, and a shading correcting method thereof.

2. Description of the Related Art

An image scanning apparatus refers to an apparatus that scans an original image such as a document, a picture, a film, etc., and produces a digital image of the original image. In the image scanning apparatus, the digital image can be displayed on a monitor of a computer, printed as an output image by a printer, transmitted to another apparatus, and so on. Such an image scanning apparatus may be a scanner, a photocopier, a facsimile machine, a multifunction peripheral (MFP) integrating one or more functions of the foregoing devices into a single device, etc.

In general, distortion may occur in an image signal generated by an image sensor due to variation or imbalance in the amount of light emitted from a light source module. This phenomenon is called “shading”, which generates an image signal different from an original image. Therefore, the image scanning apparatus is required to correct a shading phenomenon appearing in the image signal.

In order to correct the shading, a conventional method includes scanning a white reference sheet provided on one side of a flatbed to obtain reference shading data, prior to scanning an original document. However, a duplex automatic document feeder (DADF) that performs a double side scanning using two scanning units has a disadvantage in that a second scanning unit is not able to use a light source module with the white reference sheet and thus a shading correction for the second scanning unit cannot be performed. Therefore, there is a demand for a method that can automatically perform a shading correction of a second scanning unit in the DADF.

### SUMMARY

Example embodiments of the present general inventive concept provide an image scanning apparatus in which a second scanning unit scans a white area detected by a first scanning unit, to perform a shading correction of the second scanning unit, and a shading correcting method thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an image scanning apparatus including a first scanning unit to scan a first side of a conveyed document and detect a white area, a direction change unit to re-convey the conveyed document to a duplex scan path, a second scanning unit to scan the white area of the re-conveyed document, and a controller to perform a shading correction of the second scanning unit using scan data for the white area.

The first scanning unit may be disposed in a flatbed of the image scanning apparatus and may scan a white reference sheet placed opposite to the flatbed to perform a shading correction of the first scanning unit.

The image scanning apparatus may further include a storage unit to store scan data of the white reference sheet as reference shading data.

The first scanning unit may detect the white area by comparing the scan data of the scanned first side of the document with the reference shading data.

The controller may perform a shading correction of the second scanning unit by comparing the scan data of the white area with the stored reference shading data.

The controller may perform the shading correction of the second scanning unit by comparing scan data obtained by the second scanning unit scanning the white area with the scan data obtained by the first scanning unit scanning the white area.

The direction change unit may have a closed loop path such that the first side of the document scanned by the first scanning unit is changed in its advancing direction and is conveyed back toward the first scanning unit to be scanned by the second scanning unit.

The image scanning apparatus may further include a user interface to display an error message in response to no white area being detected from the first side of the conveyed document.

In response to no white area being detected from the first side of the conveyed document, the controller may control the direction change unit to re-convey the document to a duplex scan path and may control the first scanning unit to detect a white area from a second side of the re-conveyed document.

The foregoing and/or other features and utilities of the present general inventive concept may also be achieved by providing a shading correcting method of an image scanning apparatus including a first scanning unit and a second scanning unit, the method including, scanning a first side of a conveyed document and detecting a white area with a first scanning unit, re-conveying the conveyed document to a duplex scan path, scanning the white area of the re-conveyed document with a second scanning unit, and performing a shading correction of the second scanning unit using the scanned white area.

The first scanning unit may be disposed in a flatbed of the image scanning apparatus and may scan a white reference sheet placed opposite to the flatbed to perform a shading correction of the first scanning unit.

The shading correcting method may further include storing scan data of the white reference sheet as reference shading data.

The detecting of the white area may include comparing the scan data of the scanned first side of the document with the reference shading data.

The performing of the shading correction of the second scanning unit may include comparing scan data of the white area with the reference shading data.

The performing of the shading correction of the second scanning unit may include comparing scan data obtained by the second scanning unit scanning the white area with scan data obtained by the first scanning unit scanning the white area.

The re-conveying of the document to the duplex scan path may use a closed loop path such that the first side of the document scanned by the first scanning unit is changed in its advancing direction and is conveyed toward the first scanning unit to be scanned by the second scanning unit.

The shading correcting method may further include displaying an error message in response to no white area being detected from the scanned first side.

The shading correcting method may further include, in response to no white area being detected from the first side of the conveyed document, re-conveying the conveyed document to a duplex scan path and detecting a white area from the second side of the re-conveyed document.

The foregoing and/or other features and utilities of the present general inventive concept may also be achieved by providing an image scanning apparatus including a first scanning unit to detect a test area in a document, a second scanning unit to scan the test area, and a controller to perform a shading correction of the second scanning unit according to the test area.

The first and second scanning units may be configures to scan opposite sides of the document.

The image scanning apparatus may also include a direction change unit to change an advancing direction of the document such that the document is inverted and the second scanning unit scans the test area detected by the first scanning unit.

The controller may perform the shading correction by comparing the scanned test area with previously determined scan data.

The foregoing and/or other features and utilities of the present general inventive concept may also be achieved by providing a method of performing a shading correction of an image scanning apparatus including detecting a test area of a document with a first scanning unit, scanning the test area with a second scanning unit, and performing a shading correction of the second scanning unit according to the test area.

The first and second scanning units used in the method may be configured to scan opposite sides of the document.

The method may further include changing an advancing direction of the document such that the document is inverted so that the second scanning unit scans the test area detected by the first scanning unit.

The performing of the shading correction of the second scanning unit may include comparing the scanned test area with previously determined scan data.

The previously determined scan data may be obtained by the first scanning unit scanning a white sheet.

The foregoing and/or other features and utilities of the present general inventive concept may also be achieved by providing a method of performing a shading correction of an image scanning apparatus including scanning an area of one side of a document with a first scanning unit, and scanning the area with a second scanning unit to compare scan data of the first and second scanning unit.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is a block diagram illustrating an image scanning apparatus according to an exemplary embodiment of the present general inventive concept;

FIG. 2 is a schematic view illustrating an image scanning apparatus according to an exemplary embodiment of the present general inventive concept;

FIG. 3 is a view illustrating a user interface window of the image scanning apparatus; and

FIG. 4 is a flowchart illustrating an image scanning method according to an exemplary embodiment of the present general inventive concept.

### DETAILED DESCRIPTION OF THE EMBODIMENTS

Reference will now be made in detail to various exemplary embodiments of the present general inventive concept, examples of which are illustrated in the accompanying drawings, wherein like reference numerals refer to like elements throughout. The embodiments are described below in order to explain the present general inventive concept by referring to the figures.

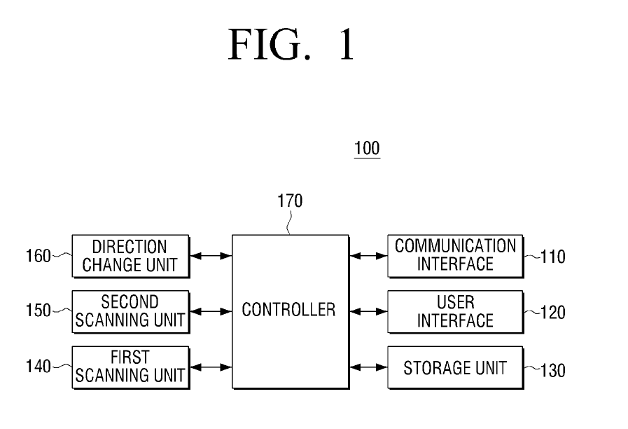

FIG. 1 is a block diagram illustrating an image scanning apparatus 100 according to an exemplary embodiment of the present general inventive concept. Referring to FIG. 1, the image scanning apparatus 100 may include a communication interface 110, a user interface 120, a storage unit 130, a first scanning unit 140, a second scanning unit 150, a direction change unit 160, and a controller 170.

The communication interface 110 may be connected to a terminal device (not shown) such as a PC, a laptop computer, a personal digital assistant (PDA), a digital camera, etc., and may transmit data scanned by the image scanning apparatus 100 to the terminal device. More specifically, the communication interface 110 may be adapted to connect the image scanning apparatus 100 to an external device, and may have access to the terminal device through a local area network (LAN) or the Internet, through a universal serial bus (USB) port, or through other connections.

The user interface 120 may receive a scan command from a user. Also, the user interface 120 may have a plurality of function keys to allow the user to set or select various functions supported by the image scanning apparatus 100, and may display information provided by the image scanning apparatus 100. The user interface 120 may be realized as a device that enables input and output to be performed simultaneously, such as a touch pad, as a device integrating a mouse and a monitor, or as other such configurations.

The storage unit 130 can store the data scanned by the image scanning apparatus 100. Also, the storage unit 130 can store shading data and reference shading data which are obtained through a procedure which will be described below. The storage unit 130 may be realized as a storage medium internal to the image scanning apparatus 100 or an external storage medium such as, for example, a removable disk including a USB memory, a storage medium connected to the host, a web server through network, and so on.

The first scanning unit 140 may be disposed in a flatbed including a white reference sheet and may be adapted to scan a first side of a document fed to the DADF. Since the first scanning unit 140 in the form of the flatbed may be represented by a conventional scanning unit in its constitution and shape, detailed description thereof will be omitted. Further, the term document as used in this description refers to any image medium capable of being scanned by the image scanning apparatus 100.

The second scanning unit 150 may be mounted in the DADF and may be adapted to scan a second side of the document opposite to the side which is scanned by the first scanning unit 140. Since the second scanning unit 150 may also be represented by a conventional scanning unit in its constitution and shape, detailed description thereof will be omitted.

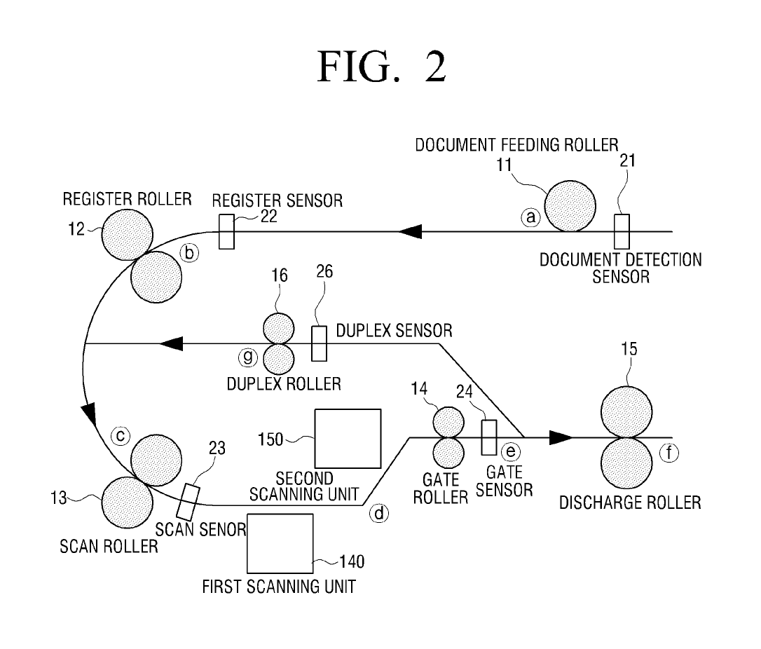

The direction change unit 160 may re-convey the document to a duplex scan path. More specifically, the direction change unit 160 may change the advancing direction of the document and re-convey the document in the direction of the first scanning unit 140 through the duplex scan path of a closed loop path, so that the first side previously scanned by the first scanning unit 140 is then scanned by the second scanning unit 150. Constitution and operation of the direction change unit 160 will be described in detail with reference to FIG. 2 below.

If a shading correction command is received from the user interface 120 or the communication interface 110, or if the number of times that scanning is performed exceeds a predetermined number, or if some other condition indicating a need for shading correction is realized, the controller 170 may control a series of operations of performing a shading correction of the first scanning unit 140 and the second scanning unit 150.

A shading correcting operation of the first scanning unit 140 may proceed as follows: The controller 170 may control the first scanning unit 140 to scan a white reference sheet placed opposite to the flatbed. Then, the controller 170 may perform a shading correction of the first scanning unit 140 using reference shading data obtained by scanning the white reference sheet. In this case, the controller 170 may store the obtained reference shading data to the storage unit 130.

A shading correcting operation for the second scanning unit 150 may proceed as follows: The controller 170 may control the first scanning unit 140 to scan the first side of document and to detect a test area, referred to in the following descriptions as a white area, in the scanned first side of the document. Herein, the “white area” refers to a series of white lines which are perpendicular to the advancing direction of the document and may be of ideal size to perform a shading correction of the second scanning unit 150. Accordingly, the controller 170 may determine whether there is a white area over a predetermined range on the first side of the document by determining whether there is a white area over a predetermined range in data scanned by the first scanning unit 140. If there is a white area on the first side of the document, the controller 170 can be aware of location information of the corresponding white area. The range of the white area can be obtained in a producing phase through a plurality of experimental results. Also, a reference value for the white area may use reference shading data obtained by scanning a white reference sheet by the first scanning unit 140. Also, the controller 170 can store scan data for the corresponding white area to the storage unit 130.

The controller 170 may control the direction change unit 160 to change the advancing direction of the document such that the detected white area is scanned by the second scanning unit 150. Accordingly, the first side of the document from which the white area has been detected by the first scanning unit 140 is turned upside down such that the first side passes through the second scanning unit 150.

The controller 170 may control the second scanning unit 150 to scan the white area from the document which has been re-conveyed after changing the advancing direction. More specifically, the controller 170 may control the second scanning unit 150 to scan the white area from the re-conveyed document using the location information of the white area detected by the first scanning unit 140 and obtain shading data.

The controller 170 may perform a shading correction of the second scanning unit 150 by referring to the scan data of the white area, i.e., the obtained shading data. More specifically, the controller 170 may perform a shading correction of the second scanning unit 150 by comparing the scan data of the white area obtained by the second scanning unit 150 with the reference shading data obtained by the first scanning unit 140 scanning the white reference sheet or the scan data obtained by the first scanning unit 140 scanning the white area of the conveyed document.

If no white area is detected from the first side of the document scanned by the first scanning unit 140, the controller 170 may control the user interface 120 to display an error message. More specifically, if there is no white area of a predetermined size to use in shading correction of the second scanning unit 150 on the document fed by the user, the controller 170 may control the user interface 120 to display an error message informing that a white image medium, such as white paper, should be fed in order to perform the shading correction. The error message may be notified to a terminal device (not shown) through the communication interface 110.

Prior to displaying the error message, the controller 170 may control the direction change unit 160 to change the advancing direction of the document to detect whether a white area exits on the second side of the initially conveyed document. If a white area is detected from neither the first side nor the second side of the inserted document, the controller 170 may control the user interface 120 to display the error message.

As described above, since the image scanning apparatus 100 can automatically perform a shading correction of the second scanning unit 150 using the white area of the currently conveyed document, a user convenience is improved.

FIG. 2 is a schematic view illustrating an image scanning apparatus according to an exemplary embodiment of the present general inventive concept.

First, a general traveling process of a document used in a duplex scan or simplex scan may be described as follows: A document detection sensor 21 may detect a presence/absence of a document. If the presence of a document is confirmed, the document stacked on a printing medium feeding tray may be fed by a document feeding roller 11. Then, the document may be separated sheet by sheet by a register roller 12 and a register sensor 22 and may be conveyed to a scan roller 13. A leading end of the document may be controlled by a scan sensor 23. Then, images on both sides of the document may be respectively scanned by the first scanning unit 140 and the second scanning unit 150 and then the document may be discharged by a gate roller 14 and a discharge roller 15. The front side of the document stacked on the paper feeding tray may be scanned by the first scanning unit 140 and the backside of the document stacked on the paper feeding tray may be scanned by the second scanning unit 150. The front side of the document may face down when passing through the discharge roller 15. Briefly, the conveying path of the document in the scanning operation, as illustrated by FIG. 2, may be â→\hat{b}→ĉ→\hat{d}→ê→\hat{f}.

A traveling process of a document in a shading correction operation may be described as follows: The document stacked on the printing medium feeding tray may pass through the document feeding roller 11, the register roller 12, the scan roller 13, and the first scanning unit 140 in the same manner as the duplex scan process. The first side of the document, referred to as the front side of the document in this description, stacked on the printing medium feeding tray may be scanned by the first scanning unit 140 and a white area may be detected on the first side of the scanned document. After that, the scanned document may pass through the gate roller 14 and then the leading end of the document may pass through the discharge roller 15. At this time, a following end of the document may be controlled by the gate sensor 24. Therefore, if the rotation of the discharge roller 15 is reversed at a predetermined position, the document may be conveyed in a direction opposite to the previous advancing direction of the document. The document conveyed in this reverse direction by the discharge roller 15 may be detected by a duplex sensor 26 and may be conveyed to the scan roller 13 by a duplex roller 16. After that, the white area of the first side of the document, i.e., the front side of the paper while stacked on the printing medium feeding tray, may be scanned by the second scanning unit 150 and the scanned white area may be obtained as shading data for the second scanning unit 150. Then, the document may be conveyed to the discharge roller 15. Briefly, the conveying path of the document during the shading correction is â→\hat{b}→ĉ→\hat{d}→ê→\hat{f}→ĝ→ĉ→\hat{d}→ê→\hat{f}.

After the shading correcting operation, the front side of the document, which faced down after the initial pass through the image scanning apparatus, again faces up. More specifically, any discharged sheets used in the shading correcting operation will be respectively reversed in orientation after the shading correcting operation compared to the orientation resulting from only the scanning operation. Also, since the document used for shading correction may not be currently scanned, the document may be reversed again at the discharge roller 15 such that the document passes along the path of â→\hat{b}→ĉ→\hat{d}→ê→\hat{f}→ĝ→ĉ→\hat{d}→ê→\hat{f}→ĝ→ĉ→\hat{d}→ê→\hat{f}.

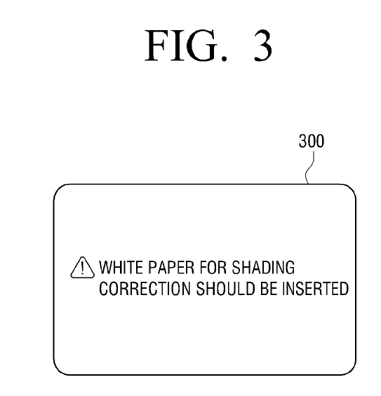

FIG. 3 is a view illustrating a user interface window displayed on the image scanning apparatus according to an exemplary embodiment of the present general inventive concept.

Referring to FIG. 3, a UI window 300 may have an area to display a message informing that a white paper to be used in shading correction should be inserted. More specifically, if there is no white area on a document currently fed from a printing medium feeding unit, the UI window 300 shown in FIG. 3 may be displayed informing the user to feed white paper to be used in shading correction into the image scanning apparatus.

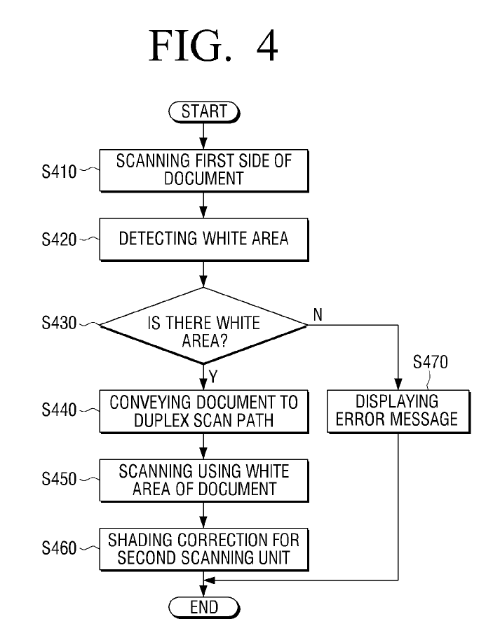

FIG. 4 is a flowchart illustrating an image scanning method according to an exemplary embodiment of the present general inventive concept.

If a shading correction command is received from a user, or if a shading correction is required as the number of times that a scanning is performed exceeds a predetermined number, or if some other condition indicating a need for shading correction is realized, a shading correction of the second scanning unit 150 may be performed using reference shading data obtained by scanning a white reference sheet placed opposite to the flatbed.

A shading correction of the second scanning unit 150 may be performed as follows: Referring to FIG. 4, the first scanning unit 140 may scan a first side of a conveyed document in operation S410. A white area may be detected from the scanned first side of the document in operation S420. More specifically, the first scanning unit 140 may detect location information of the white area of a predetermined range from the scanned first side of the document. The range of the white area may be obtained in a producing phase through a plurality of experimental results. Herein, the white area may refer to a series of white lines which are perpendicular to the advancing direction of the document and may be of ideal size to perform a shading correction for the second scanning unit 150.

Next, it may be determined whether there is a white area on the scanned first side of the document in operation S430. If there is a white area on the first side, the advancing direction of the document may be changed such that the document is re-conveyed to the duplex scan path in operation S440. Changing the advancing direction of the document was described in detail with reference to FIG. 2.

A shading correction of the second scanning unit 150 may be performed by scanning the white area on the document which has been changed in its advancing direction and re-conveyed and obtaining shading data in operation S450. More specifically, shading data may be obtained by scanning the white area on the first side of the re-conveyed document based on the location information of the white area detected by the first scanning unit 140. The scan data for the white area, i.e. the obtained shading data, may be compared with reference shading data obtained by the first scanning unit 140 scanning a white reference sheet or with scan data obtained by the first scanning unit 140 scanning the white area of the conveyed document.

Alternatively, if the first scanning unit 140 does not detect a white area from the scanned first side of the document, an error message may be displayed in operation S460. More specifically, if there is no white area having a predetermined size that may be ideal to perform a shading correction of the second scanning unit 150 on the conveyed document, an error message may be displayed instructing a user to feed white paper to be used in shading correction into the image scanning apparatus 100.

Also, prior to displaying the error message, the advancing direction of the conveyed document may be changed and whether there is a white area on the second side of the direction-changed document may be detected. Then, an error message may be displayed if a white area is detected from neither the first side nor the second side.

Accordingly, since a shading correction of the second scanning unit 150 is automatically performed using a white area of a currently conveyed document, user convenience is improved. The image scanning method of FIG. 4 can be applied to the image scanning apparatus 100 of the configuration of FIG. 1 and also can applied to other image scanning apparatuses of various different configurations.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. An image scanning apparatus, comprising:
a first scanning unit to scan a first side of a conveyed document and detect a white area;
a direction change unit to re-convey the conveyed document to a duplex scan path;
a second scanning unit to scan the white area of the re-conveyed document; and
a controller to perform a shading correction of the second scanning unit using scan data of the white area.

2. The image scanning apparatus of claim 1, wherein the first scanning unit is disposed in a flatbed of the image scanning apparatus and scans a white reference sheet placed opposite to the flatbed to perform a shading correction of the first scanning unit.

3. The image scanning apparatus of claim 2, further comprising:
a storage unit to store scan data of the white reference sheet as reference shading data.

4. The image scanning apparatus of claim 3, wherein the first scanning unit detects the white area by comparing the scan data of the scanned first side of the document with the reference shading data.

5. The image scanning apparatus of claim 3, wherein the controller performs a shading correction of the second scanning unit by comparing the scan data of the white area with the stored reference shading data.

6. The image scanning apparatus of claim 1, wherein the controller performs the shading correction of the second scanning unit by comparing scan data obtained by the second scanning unit scanning the white area with the scan data obtained by the first scanning unit scanning the white area.

7. The image scanning apparatus of claim 1, wherein the direction change unit has a closed loop path such that the first side of the document scanned by the first scanning unit is changed in its advancing direction and is conveyed back toward the first scanning unit to be scanned by the second scanning unit.

8. The image scanning apparatus of claim 1, further comprising:
a user interface to display an error message in response to no white area being detected from the first side of the conveyed document.

9. The image scanning apparatus of claim 1, wherein, in response to no white area being detected from the first side of the conveyed document, the controller controls the direction change unit to re-convey the document to a duplex scan path and controls the first scanning unit to detect a white area from a second side of the re-conveyed document.

10. A shading correcting method of an image scanning apparatus comprising a first scanning unit and a second scanning unit, the method comprising:
scanning a first side of a conveyed document and detecting a white area with a first scanning unit;
re-conveying the conveyed document to a duplex scan path;
scanning the white area of the re-conveyed document with a second scanning unit; and
performing a shading correction of the second scanning unit using the scanned white area.

11. The shading correcting method of claim 10, wherein the first scanning unit is disposed in a flatbed of the image scanning apparatus and scans a white reference sheet placed opposite to the flatbed to perform a shading correction of the first scanning unit.

12. The shading correcting method of claim 11, further comprising:
storing scan data of the white reference sheet as reference shading data.

13. The shading correcting method of claim 12, wherein the detecting the white area comprises:
comparing the scan data of the scanned first side of the document with the reference shading data.

14. The shading correcting method of claim 10, wherein the performing of the shading correction of the second scanning unit comprises:
comparing scan data of the white area with the reference shading data.

15. The shading correcting method of claim 10, wherein the performing of the shading correction of the second scanning unit comprises:
comparing scan data obtained by the second scanning unit scanning the white area with scan data obtained by the first scanning unit scanning the white area.

16. The shading correcting method of claim 10, wherein the re-conveying of the document to the duplex scan path uses a closed loop path such that the first side of the document scanned by the first scanning unit is changed in its advancing direction and is conveyed toward the first scanning unit to be scanned by the second scanning unit.

17. The shading correcting method of claim 10, further comprising:
displaying an error message in response to no white area being detected from the scanned first side.

18. The shading correcting method of claim 10, further comprising:
In response to no white area being detected from the first side of the conveyed document, re-conveying the conveyed document to a duplex scan path and detecting a white area from the second side of the re-conveyed document.

19. A method of performing a shading correction of an image scanning apparatus, the method comprising:
detecting a test area of a document with a first scanning unit;
scanning the test area with a second scanning unit;
performing a shading correction of the second scanning unit according to the test area; and
changing an advancing direction of the document such that the document is inverted and the second scanning unit scans the test area detected by the first scanning unit,
wherein the first and second scanning units are configured to scan opposite sides of the document.

20. The method of claim 19, wherein the performing the shading correction of the second scanning unit comprises:
comparing the scanned test area with previously determined scan data.
